(19) United States
(12) Patent Application Publication
(10) Pub. No.: US 2011/0209617 A1
(43) Pub. Date: Sep. 1, 2011

(54) FILTER FOR EXHAUST AIR BOX AND A METHOD FOR CLEANING USED FILTER MATERIAL

(75) Inventor: Ronny Pihlblad, Veddige (SE)

(73) Assignee: PIVAB INTERNATIONAL AB, Veddige (SE)

(21) Appl. No.: 13/125,184

(22) PCT Filed: Oct. 14, 2009
(86) PCT No.: PCT/SE2009/051170

§ 371 Date: May 11, 2011

(30) Foreign Application Priority Data
Oct. 21, 2008 (SE) 0802240-2

(51) Int. Cl. B01D 46/30; B01D 41/02

(52) U.S. Cl. 95/282; 55/462; 55/332

(57) ABSTRACT

The invention refers to a filter for an exhaust air box (2) between a space (1) containing powder mixed air and an outlet opening (2a), and where the filter is arranged to be passed by a flow of exhaust air, and to thereby capture the major part of powder carried in the flow of exhaust air, whereby the filter incorporates a portion (10) consisting of a multi-stage bed of balls of light expanded clay (10a) arranged on a grate-formed carrier (9a), the openings of which are of a size 9 which allows the carrier (9a) to serve as base for the balls (10a) without letting individual balls pass, and by which a network of labyrinth-formed passages mutually between the balls (10a) and between the balls (10a) and the grate-formed carrier (9a). The invention also refers to a method for cleaning such filter material, which incorporates tumbling of the material.

### FIELD OF THE INVENTION

In closed spaces where material treatment is effected by means of flows of air, which carry paint pigments, solvents and/or other components, which should not reach the ambient atmosphere, it is necessary to use a filter, which is positioned in at least one exhaust air box, which is situated between the closed space and an outlet from this. Thereby, the task of the filter is to trap particles in the exhaust air.

### BACKGROUND OF THE INVENTION

The present invention refers to a filter for an exhaust air box, e.g. at a paintbox, where the filter material during the use of the paintbox is flushed by air having large numbers of particles which are suspended in the air, and at paintboxes particularly of a high portion of paint particles suspended in the air. Those particles, which should be separated as far as possible from the air leaving the exhaust air boxes, are trapped by the filter material with which the exhaust air boxes are armed and this means in turn that the filter material after a comparatively short time will be saturated by particles, which have been trapped during the use of the paintbox.

At paintboxes usually the entire floor space, except for possible necessary lift arrangements and the like, is designed as a number of exhaust air boxes arranged adjacent each other and shaped as cassettes in which is positioned a primary filter facing the interior of the box and a secondary filter provided thereafter. These primary and secondary filters are supported by grate shaped carriers or bottoms, and they are often designed as thick glass fiber carpets. As the primary filter shall absorb a major part of the paint particles, which accompanies the exhaust air, it is understood that this primary filter must be cleaned at regular intervals. As there today is no known technique for easily regenerating a filter made from a glass fiber carpet, the filter cassette in question must be dismounted from the paintbox, and positioned in a receptacle for transport to destruction and/or recycling, whereupon a new filter insert can be mounted before the paintbox can be put in service again. The cost for a single glass fiber carpet for a primary or secondary filter will amount to several thousand Swedish Crowns, and as every paintbox can have a rather large number of exhaust air boxes, it can be understood that the cost for updating only the primary filter can become rather high.

The invention also refers to a method for regeneration of filter material being a part of such a filter.

### PURPOSE AND MOST EVIDENT FEATURES OF THE INVENTION

A purpose with the present invention is to offer a filter for an exhaust air box for a site for treatment of objects, with a high portion of particles in the exhaust air, which filter has an increased service life compared to earlier filters and this has been achieved in that the filter has been given the features defined in the accompanying claim 1. Another purpose of the invention is to suggest a method for regeneration of filter material forming part of the filter in a simple and cost efficient manner, and this has been achieved in that the method has been given the features defined in the accompanying claim 7.

### BRIEF DESCRIPTION OF THE DRAWINGS

Hereinafter the invention will be described more in detail with reference to embodiments illustrated in the accompanying drawings.

FIG. 1 shows diagrammatically in cross-section a paintbox with a number of exhaust air boxes provided in the lower part of the paintbox,

FIG. 2 shows obliquely from above an exhaust air box with a bottom grate,

FIG. 3 shows how a secondary filter layer is positioned on the bottom grate,

FIG. 4 shows how the secondary filter material has been positioned on the bottom grate, and how another filter portion with the primary filter material is waiting to be positioned thereon.

FIG. 5 shows how the primary filter material has been positioned on top of the secondary filter material, and where at a portion of the filter the primary filter material has been removed thus that it is possible to see the grate-formed carrier for the primary filter material.

FIG. 6 illustrates in a cross-section view how the upper part of the filter facing the interior of the paintbox is composed by a number of layers of light expanded clay, resting on each other, and

FIG. 7 illustrates schematically a device for regeneration of the material in the primary filter layer.

### DESCRIPTION OF PREFERRED EMBODIMENTS

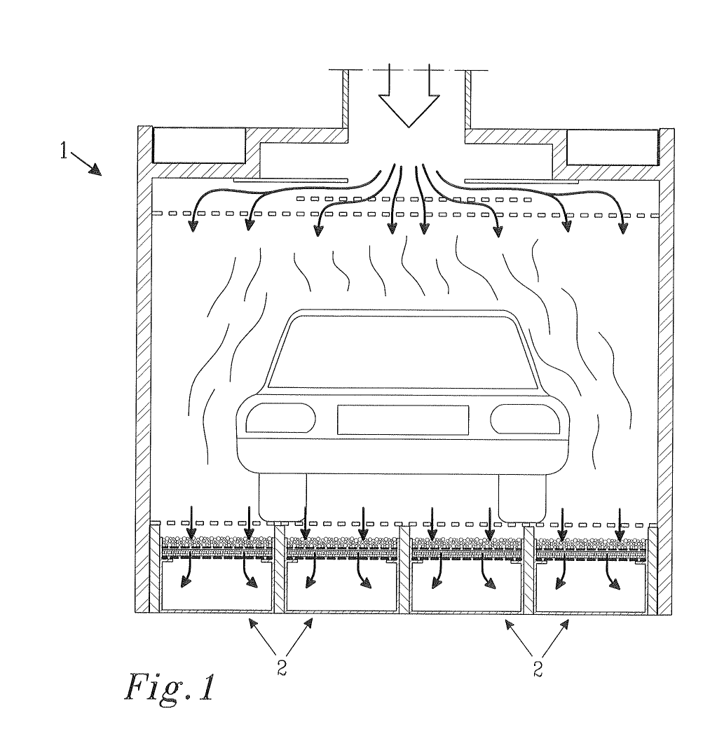

In FIG. 1 is schematically shown a cross-section of a paintbox 1 with an illustration of how inlet air is introduced by means of a not further shown fan arrangement at the upper part of the paintbox, whereby the inlet air is filtered in a not further shown filter bank before the inlet air reaches the roof of the paintbox. In the space delimited by the roof, the walls and the floor of the paintbox is effected the treatment or work of objects, which shall take place in the paintbox, e.g. painting of cars or other treatment of objects, where large amounts of particles will become suspended in the air introduced in the paintbox, such as paint particles or particles of solvents.

At the floor of the box 1 are provided a number of exhaust air boxes 2, through which the exhaust air, which thus during operation is heavily mixed up with dust, shall be passed out of the box under influence of a not further shown exhaust air fan. In the embodiment illustrated, the cross section of the bottom region of the box has four such exhaust air boxes and as the box can be long, particularly if it refers to a paintbox, which shall be able to accommodate a passenger car for painting, it is understood that every exhaust air box 2 in the longitudinal direction is subdivided in a number of units. In other words, every box will incorporate a rather large number of such exhaust air boxes.

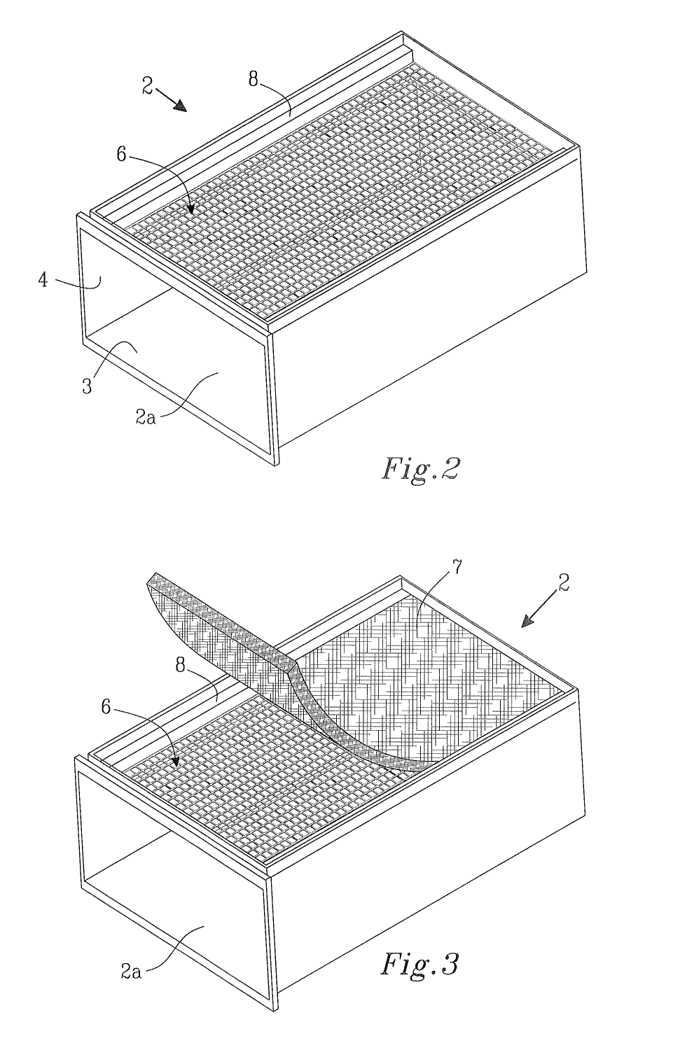

In FIG. 2 is shown a perspective view of an exhaust air box 2, which incorporates a gutter-formed element with a complete bottom 3, two longitudinal side walls 4, 5 arranged substantially at right angles thereto and a grate floor 6 resting on a not further shown base. In the embodiment shown, both short sides are open, but alternatively one of the short sides can be constituted by a completely hermetic wall, whereas the other forms an outlet opening 2a.

In FIG. 3 is illustrated how a secondary filter 7, preferably a mat of glass fibre fabric is positioned on the grate floor 6, thus that there are no open slots, which are not covered by the secondary filter. As can be seen in the figure there is a stepped flange 8 between the edge of the secondary filter and the sidewalls.

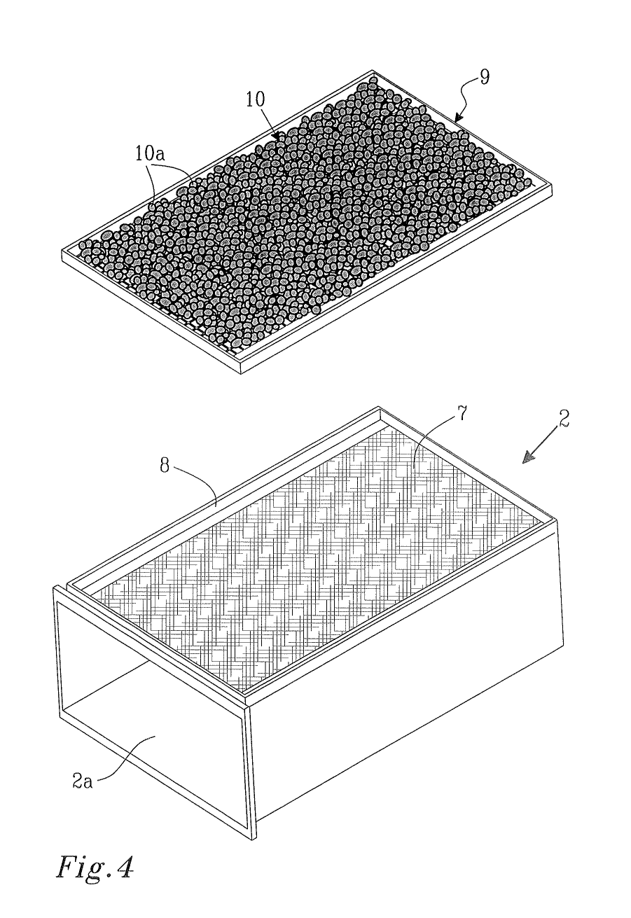

FIG. 4 shows how the mat of glass fibre fabric, which forms the secondary filter 7, has been positioned to rest on the grate floor 6, which is visible in FIG. 3, and how a cassette 9 with a primary filter 10 is ready to be positioned on the stepped flange 8, shown in the figure. This primary filter 10 is composed by a multi-layer of balls 10a of light expanded clay (Light Expanded Clay Aggregate), which under the trade name LECA is marketed for insulating purposes and as filler material within the construction area and which is available on the market in different sizes, from between 1 and 2 mm in diameter and up to between 10 and 20 mm in diameter. As filter bed, sizes between 8 and 16 mm in diameter are preferably used. The volumetric weight in dry state for such balls of expanded clay is between 300 and 500 kg/m³.

In FIG. 5 is shown how the cassette 9 has been positioned on top of the lower part of the filter, shown in FIG. 4. For illustrative reasons, the multi-stage layer of the balls 10a of expanded clay has been removed from a portion of the cassette 9 for showing that the cassette 9 at the lower side has a grate-formed carrier 9a, the openings of which have a size allowing that the carrier 9a can act as a base for the balls 10a without letting through individual balls 10a, and which results in that a network of labyrinth-formed passages are formed mutually between the balls 10a and between the balls 10a and the grate-formed carrier 9a at the lower side of the cassette, through which passages air from the interior of the paintbox 1 or the like is conducted before this exhaust air reaches the secondary filter 7. Surprisingly it has proven itself that paint and solvent material in the air leaving the paintbox 1, at the passage through the multi-stage layer of balls of light expanded clay will attach to these balls, whereby very small residual amounts of material is left in the exhaust air when this reaches the secondary filter 7. After the exhaust air has passed the secondary filter 7 it will leave the exhaust air box 2 through the single open side or through both the open sides.

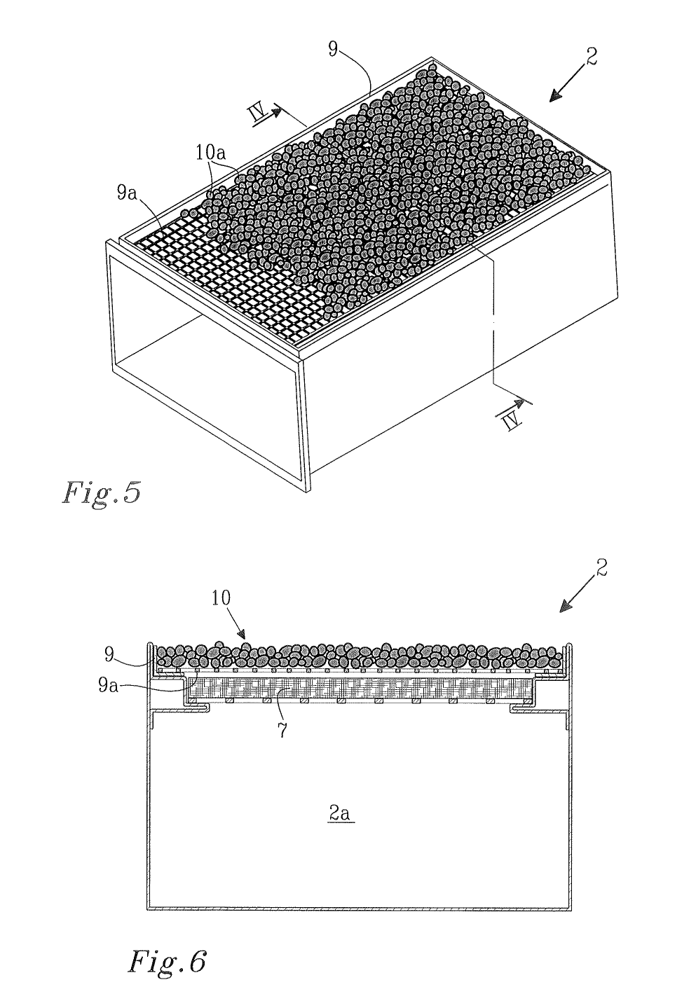

In FIG. 6 is shown an exhaust air box 2 according to FIG. 5, whereby the multi-stage layer of expanded clay balls is shown with two to three layers, but the number of layers is preferably larger, and an overall height of this multi-stage layer of expanded clay balls can preferably be between 5 and 10 cm and most preferably about 7 cm, which has proven itself to give a good filtering ability with reference to paint material and the like.

It has been found that paint material will stick very well to the somewhat rugged and porous surface of the balls of expanded clay, but it has at the same time surprisingly turned out that the paint material can again easily be removed if the balls are subjected to centrifugal forces.

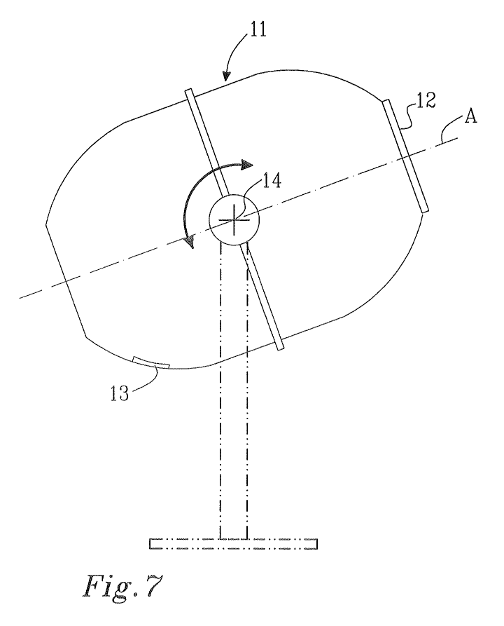

Thereby it has shown itself to be suitable to empty the filter material from the primary filter into a vessel 11 schematically illustrated in FIG. 7, and which is rotatable about an axis A-A and which has a filling and emptying opening 12 at one end of the vessel and a preferably closable outlet opening 13 for paint material, which during rotation of the vessel has come loose from the balls of expanded clay and thereby gathered in the lower part of the vessel.

After the vessel with paint mixed balls of expanded clay has been rotated for a period of time, the rotation is stopped when the outlet opening 13 is situated at its lowermost position, whereby the opening is opened and the loosened paint material is allowed to fall down into a not shown collecting receptacle for subsequent transport to a destruction or recovery site. When the loosened paint material has been emptied from the vessel 11, this vessel can be pivoted about a suspension axis 14, thus that the cleaned balls of expanded clay can be emptied from the vessel 11 through its opening 12.

It has proven itself that the balls which have been tumbled at the rotation of the vessel, have released so much of the earlier attaching paint material, that these balls of expanded clay again can be filled in a cassette 9 and thereby be reused as primary filter.

It has also turned out that the volume of balls of expanded clay, which is substantially less expensive as compared to a corresponding glass fibre mat, can also be reused a large number of times before it must be considered to have been used up, and thereby the cost for the primary filter is further reduces in comparison with the exhaust air filters with glass fibre mats earlier used in the secondary filter as well as in the primary filter.

The invention is not limited to the embodiments illustrated in the drawing figures and described in connection thereto, but modifications and variants are possible within the scope of the accompanying claims.

1. Filter for an exhaust air box between a space holding powder mixed air and an outlet opening, and where the filter is arranged to be passed by a flow of exhaust air, and to thereby capture the major part of powder carried in the flow of exhaust air, wherein,
that the filter incorporates a portion consisting of a multi-stage bed of balls of light expanded clay arranged on a grate-formed carrier, the openings of which are of a size which allows the carrier to serve as base for the balls without letting individual balls pass, and by which is formed a network of labyrinth-formed passages mutually between the balls and between the balls and the grate-formed carrier.

2. The filter as claimed in claim 1, wherein,
that at least one secondary filter is arranged between the filter portion consisting of a multi-stage bed of balls of expanded clay and the outlet opening of the exhaust air box.

3. The filter as claimed in claim 2, wherein,
that said secondary filter consists of a glass fiber mat.

4. The filter as claimed in claim 1, wherein,
that balls in the filter portion consisting of a multi-stage bed of balls of light expanded clay have a grain size of between 1 and 20 mm, preferably between 8 and 16 mm.

5. The filter as claimed in claim 1, wherein,
that the filter portion consisting of a multi-stage bed of balls of light expanded clay has a thickness of between 5 and 10 cm, preferably about 7 cm.

6. The filter as claimed in claim 1, wherein,
that the filter portion consisting of multi-stage bed of balls of light expanded clay is designed as a cassette, the bottom of which constitutes the said grate-formed carrier and which with its edges is arranged to rest on an inwardly projecting flange provided in the inner side of the exhaust air box.

7. A method for cleaning used filter material according to claim 1, wherein,
that the balls of light expanded clay from the used filter portion are positioned in a rotatable vessel, that the vessel is rotated thus that the balls are subjected to a centrifugal force, whereby powder collected on the balls comes loose, and thereupon can be emptied from the vessel, whereupon the balls of light expanded clay are again positioned in the multi-stage bed and can be used again.
